(19) United States
(12) Patent Application Publication
(10) Pub. No.: US 2016/0373195 A1
(43) Pub. Date: Dec. 22, 2016

(54) TERMINAL DEVICE, BASE STATION APPARATUS, AND TRANSMISSION METHOD

(71) Applicant: SHARP KABUSHIKI KAISHA, Osaka-shi (JP)

(72) Inventors: Katsuya KATO, Osaka-shi (JP); Ryota YAMADA, Osaka-shi (JP); Kozue YOKOMAKURA, Osaka-shi (JP); Hiromichi TOMEBA, Osaka-shi (JP)

(73) Assignee: SHARP KABUSHIKI KAISHA, Osaka-shi (JP)

(21) Appl. No.: 14/902,132

(22) PCT Filed: Jun. 10, 2014
(86) PCT No.: PCT/JP2014/065361

§ 371 Date: Dec. 30, 2015

(30) Foreign Application Priority Data
Jul. 4, 2013 (JP) 2013-140568

(51) Int. Cl. H04B 17/309; H04W 24/08

(52) U.S. Cl. CPC H04B 17/309; H04W 24/08

(57) ABSTRACT

A terminal device, a base station apparatus, a transmission method, configured to perform interference cancellation at a higher accuracy level are provided. The terminal device reports, to the base station apparatus connected thereto, first channel information serving as channel information with the base station, and second channel information serving as channel information with an interfering base station. The channel information includes a channel quality indicator, and the terminal device reports, to the base station apparatus connected thereto, a first channel quality indicator serving as a channel quality indicator with the base station apparatus, and a second channel quality indicator serving as a channel quality indicator with the interfering base station.

### TECHNICAL FIELD

The present invention relates to a terminal device, a base station apparatus, and a transmission method.

### BACKGROUND ART

As smart phones and tablet terminals are widely used, traffic in mobile communication is increasing exponentially and is expected to increase even further. A dense deployment of base stations in a heterogeneous network is under study as a step to the increase in radio traffic. The dense deployment of base stations includes, in a macro cell, low power nodes (LPNs) where each terminal device is connected to a low power node. The workload on a macro base station is thus reduced. In this case, however, inter-cell interference becomes problematic.

Concerning the inter-cell interference, NAICS (Network Assisted Interference Cancellation and Suppression) with a terminal device configured to suppress or cancel an interference signal is under study in 3GPP (3rd Generation Partnership Project). In NAICS, the terminal device receives information related to another terminal device serving as an interfering source, detects a signal addressed to the interfering terminal device, and then cancels the interference. NAICS is described in Non Patent Literature 1.

### CITATION LIST

### Non Patent Literature

NPL 1: RP-130404, “Study on Network-Assisted Interference Cancellation and Suppression for LTE,” 3GPP TSG RAN Meeting #59, March 2013

### SUMMARY OF INVENTION

### Technical Problem

Interference cancellation performance is lowered in a case that a signal to another terminal device serving as an interference source is MCS (Modulation and Coding Scheme) that provides a low detection accuracy to the terminal device. Low transmission efficiency thus results.

The present invention has been developed in view of this problem, and is intended to provide a terminal device, a base station apparatus, and a transmission method, configured to achieve a high-accuracy interference cancellation level using NAICS.

### Solution to Problem

The terminal device, the base station apparatus, and the transmission method of the present invention intended to solve the above problem are constituted as described below.

(1) According to one embodiment of the present invention, there is provided a terminal device. The terminal device is configured to report, to a base station apparatus connected thereto, first channel information serving as channel information with the base station, and second channel information serving as channel information with an interfering base station.

(2) In the terminal device of the present invention, the channel information includes a channel quality indicator. The terminal device reports, to the base station apparatus connected thereto, a first channel quality indicator serving as a channel quality indicator with the base station, and a second channel quality indicator serving as a channel quality indicator with the interfering base station.

(3) In the terminal device of the present invention, the first channel quality indicator and the second channel quality indicator are quoted from different tables.

(4) In the terminal device of the present invention, the second channel quality indicator is a difference from the first channel quality indicator.

(5) In the terminal device of the present invention, the terminal device reports to the base station apparatus a third channel quality indicator that is a channel quality indicator in a case that interference from the interfering base station is not cancelled.

(6) In the terminal device of the present invention, the third channel quality indicator is a difference from the first channel quality indicator.

(7) In the terminal device of the present invention, the channel information includes a rank indication. The terminal device reports, to the base station apparatus connected thereto, a first rank indication serving as a rank indication with the base station, and a second rank indication serving as a rank indication with the interfering base station.

(8) In the terminal device of the present invention, the terminal device reports to the base station apparatus a maximum rank number that is MIMO separable by the terminal device.

(9) In the terminal device of the present invention, the terminal device reports to the base station apparatus a difference between a maximum rank number that is MIMO separable by the terminal device and a rank number of a channel with the base station connected to the terminal device.

(10) In the terminal device of the present invention, the channel information includes a pre-coding matrix indicator. The terminal device reports, to the base station apparatus connected thereto, a first pre-coding matrix indicator serving as a pre-coding matrix indicator with the base station, and a second pre-coding matrix indicator serving as a pre-coding matrix indicator with the interfering base station.

(11) In the terminal of the present invention, the second pre-coding matrix indicator configured to increase received power of an interference channel is selected.

(12) In the terminal device of the present invention, reporting the first channel quality indicator and reporting the second channel quality indicator are performed at the same timing.

(13) In the terminal device of the present invention, reporting the first channel quality indicator and reporting the second channel quality indicator are performed at different timings.

(14) In the terminal device of the present invention, reporting the first channel quality indicator, reporting the second channel quality indicator, and reporting the third channel quality indicator are performed at the same timing.

(15) In the terminal device of the present invention, reporting the first channel quality indicator, reporting the second channel quality indicator, and reporting the third channel quality indicator are performed at different timings.

(16) In the terminal device of the present invention, period of reporting the second channel quality indicator is different from a period of reporting the second rank indication.

(17) In the terminal device of the present invention, the channel information includes a pre-coding matrix indicator. The terminal device reports, to the base station apparatus connected thereto, a first pre-coding matrix indicator serving as a pre-coding matrix indicator with the base station, and a second pre-coding matrix indicator serving as a pre-coding matrix indicator with the interfering base station. A period of reporting the second rank indication is equal to a period of reporting the second pre-coding matrix indicator.

(18) According to one embodiment of the present invention, there is provided a base station apparatus. The base station apparatus is configured to request a terminal device to report first channel information serving as channel information with the base station apparatus, and second channel information serving as channel information with an interfering base station.

(19) In the base station apparatus of the present invention, the channel information includes a channel quality indicator. The base station apparatus requests the terminal device to report a first channel quality indicator serving as a channel quality indicator with the base station and a second channel quality indicator serving as a channel quality indicator with the interfering base station.

(20) In the base station apparatus of the present invention, the channel information includes a rank indication. The base station apparatus requests the terminal device to report a first rank indication serving as a rank indication with the base station apparatus and a second rank indication serving as a channel quality indicator with the interfering base station.

(21) In the base station apparatus of the present invention, the base station apparatus requests the terminal device to report a maximum rank number MIMO separable by the terminal device.

(22) In the base station apparatus of the present invention, the base station apparatus requests the terminal device to report a difference between a maximum rank number MIMO separable by the terminal device and an instantaneous rank number a channel between the terminal device and the base station apparatus.

(23) In the base station apparatus of the present invention, the channel information includes a pre-coding matrix indicator. The base station apparatus requests the terminal device to report a first pre-coding matrix indicator serving as a pre-coding matrix indicator with the base station apparatus, and a second pre-coding matrix indicator serving as a pre-coding matrix indicator with the interfering base station.

(24) In the base station apparatus of the present invention, requesting the first channel quality indicator and requesting the second channel quality indicator are performed at the same timing.

(25) In the base station apparatus of the present invention, requesting the first channel quality indicator and requesting the second channel quality indicator are performed at different timings.

(26) In the base station apparatus of the present invention, a period of reporting the second channel quality indicator is different from a period of requesting the second rank indication.

(27) In the base station apparatus of the present invention, the channel information includes a pre-coding matrix indicator. The base station apparatus requests the terminal device to report a first pre-coding matrix indicator serving as a pre-coding matrix indicator with the base station apparatus and a second pre-coding matrix indicator serving as a pre-coding matrix indicator with the interfering base station apparatus. A period of requesting the second rank indication is equal to a period of requesting the second pre-coding matrix indicator.

(28) According to one embodiment of the present invention, there is provided a transmission method of a terminal device. The transmission method includes reporting, to a base station apparatus connected thereto, first channel information serving as channel information with the base station, and second channel information serving as channel information with an interfering base station.

### Advantageous Effects of Invention

According to the present invention, transmission efficiency is increased.

### BRIEF DESCRIPTION OF DRAWINGS

FIG. 1 illustrates an example of a communication system of a first embodiment of the present invention.

FIG. 2 is a sequence chart of a process performed between a base station apparatus and a terminal device of the first embodiment of the present invention.

FIG. 3 is a block diagram diagrammatically illustrating a configuration of the base station apparatus of the first embodiment of the present invention.

FIG. 4 is a block diagram diagrammatically illustrating a configuration of the terminal device of the first embodiment of the present invention.

FIG. 5 illustrates an example of a channel quality indicator.

### DESCRIPTION OF EMBODIMENTS

Embodiments of the present invention are described below with reference to the attached drawings.

In the embodiments described below, a base station apparatus (such as eNodeB, transmitting station, transmission apparatus, transmission point, access point (AP), cell, transmit antenna group, transmit antenna port group, or component carrier) and a terminal device (such as a terminal, mobile station apparatus, mobile terminal, reception point, reception terminal, reception apparatus, receive antenna group, receive antenna port group, or UE: User Equipment) perform data exchange using OFDM (Orthogonal Frequency Division Multiplexing) system. In the embodiments described below, other transmission systems may also be employed. Such transmission systems may include a single carrier transmission system, such as narrow-band single carrier transmission, SC-FDMA (Single Carrier-Frequency Division Multiple Access), or DFT-s-OFDM (Discrete Fourier Transform-spread-OFDM), or a multi-carrier transmission system such as MC-CDMA (Multiple Carrier-Code Division Multiple Access). The wireless communication system of the embodiments of the present invention includes but is not limited to WCDMA (registered trademark) (Wideband Code Division Multiple Access), LTE (Long Term Evolution) and LTE-A (LTE-Advanced) by 3GPP (3rd Generation Partnership Project), and WiMAX (Worldwide Interoperability for Microwave Access) by IEEE (The Institute of Electrical and Electronics Engineers).

### First Embodiment

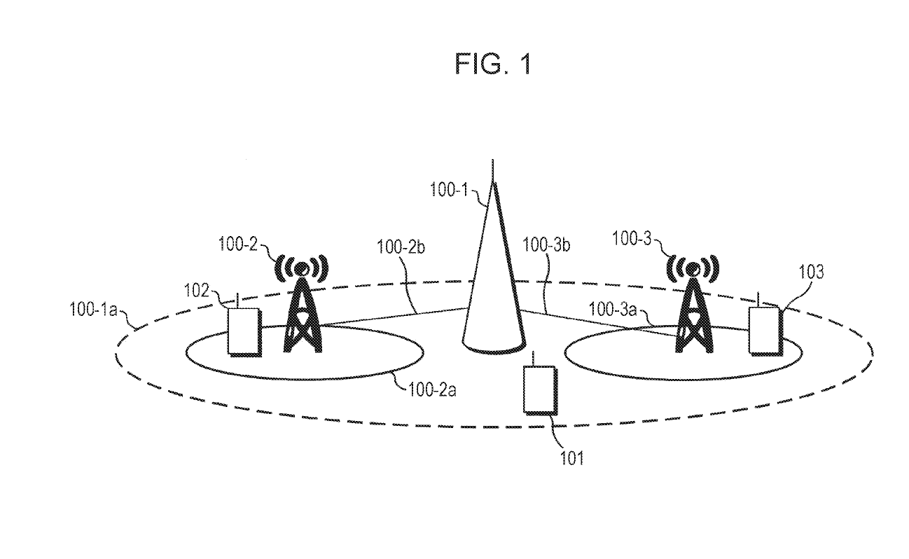

A first embodiment of the present invention is described below. FIG. 1 illustrates an example of a communication system of the first embodiment of the present invention. The communication system of FIG. 1 includes a base station apparatus (also referred to as a macro base station or a first base station) 100-1, base station apparatuses (also referred to as LPN: Low Power Node, a low-power base station, or a second base station) 100-2 and 100-3 lower in transmit power than the macro base station, terminal devices 101, 102, and 103. The macro base station apparatus 100-1 has a coverage (macro cell) 100-1a, low-power base stations 100-2 and 100-3 have coverage (also referred to as a pico cell or a small cell) 100-2a and 100-3a. The term coverage refers an area within which the base station apparatus remains connectable with the terminal device (communication area). The macro base station apparatus 100-1 is in communication with the low-power base stations 100-2 and 100-3 via 100-2b and 100-3b. In the discussion that follows, the connections 100-2b and 100-3b are wired connections, but may be a radio connection. There may be a connection established between the low-power base stations 100-2 and 100-3. In the following discussion, the macro base station and the low-power base stations form a multi-cell. The present invention is not limited to this configuration. For example, the multi-cell may be formed by a macro base station alone, or low-power base stations alone. Referring to FIG. 1, the macro base station apparatus 100-1 is connected to the terminal device 101, the low-power base station 100-2 is connected a terminal device 102, and the low-power base station 100-3 is connected to a terminal device 103. In this example, a single terminal device is connected to each base station, but the case in which multiple terminal devices are connected to each base station falls within the scope of the present invention.

In a case that there are multiple low-power base stations, the low-power base stations may be different in transmit power. The macro base station is discriminated from the low-power base station in transmit power. Also, the base stations may be discriminated in terms of whether the base station is a station having backward compatibility that supports a previously introduced service or a newly defined station having no backward compatibility. The macro base station may be discriminated from the low-power base station according to a cell ID or the like.

The low-power base stations may be different from each other in terms of service system (version or option of the communication system).

The present invention is not limited to the following embodiments in terms of the number of cells, the number of base stations, the number of terminal devices, the type of cells (such as macro cell, pico cell, femto cell, or small cell). Referring to FIG. 1, the small cell fully overlaps the macro cell, but the small cell may partially overlap the macro cell, or the small cell may not overlap the macro cell at all.

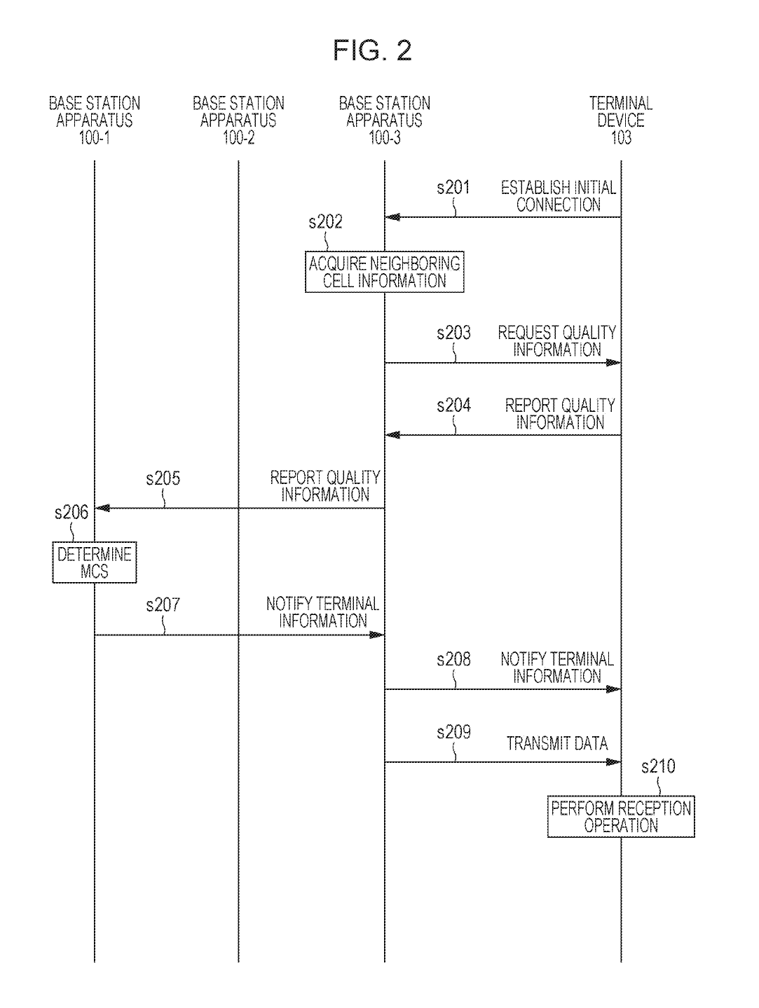

FIG. 2 is a sequence chart of a process performed between the base station apparatus and the terminal device of the present embodiment of the present invention. In a case described below, the terminal device 103 is connected to the low-power base station 100-3. It is assumed that the terminal device 103 receives interference signals from the base station apparatuses 100-1 and 100-2. The terminal device 103 detects a cell (cell ID) available for communication using a synchronization signal for cell searching, and establishes an initial connection with the base station apparatus 100-3 (step s201). The base station apparatus 100-3 recognizes a neighboring cell (step s202). The base station apparatus 100-3 requests the terminal device 103 to perform channel estimation of the neighboring cell and to report quality information resulting from a channel estimation value (step s203). The terminal device 103 performs the channel estimation with the base station apparatus 100-3 and reports to the base station apparatus 100-3 the quality information including a channel quality indicator (CQI), a pre-coding matrix indicator (PMI) as information indicating pre-coding desired by the terminal device 103, and a rank indication (RI) as information indicating a rank number of the terminal device 103. The CQI, PMI, and RI of a desired channel between the terminal device and the base station apparatus connected to the terminal device are respectively a first CQI, a first PMI, and a first RI. For example, the CQI of the channel between the base station apparatus 100-3 and the terminal device 103 is the first CQI. The CQI of the channel between the base station apparatus 100-2 and the terminal device 102 is the first CQI. The first CQI may be a value that is assumed to be interference canceled. For example, the first CQI of the terminal device 103 is a value that is based on the assumption that interference from the macro base station apparatus 100-1 and the base station apparatus 100-2 is canceled. The first CQI, the first PMI, the first RI, and the like are referred to as first channel information. The terminal device 103 performs channel estimation with the base station apparatus 100-1 and reports the CQI of the base station apparatus 100-1 as the quality information to the base station apparatus 100-3. In the following discussion, the CQI of such an interference channel is referred to as an interference channel quality indicator (an interference CQI, a second CQI, or a second channel quality indicator). Information concerning interference, such as the interference CQI fed back from the terminal device, is second channel information. The terminal device 103 performs the channel estimation with the base station apparatus 100-2, and reports the interference CQI as the quality information to the base station apparatus 100-3 (step s204). The base station apparatus 100-3 reports the quality information reported by the terminal device 103 to the base station apparatus 100-1 (step s205). Note that the terminal devices 101 and 102 (not illustrated) also report the quality information in a similar fashion, and at the same timing, the base station apparatus 100-1 learns each pieces of quality information. The base station apparatus 100-1 performs a scheduling operation using the recognized quality information of the terminal devices 101, 102, and 103, and determines terminal information including MCS (Modulation and Coding Scheme), the rank number, and the like from the base station apparatus 100-1 to the terminal device 101, from the base station apparatus 100-2 to the terminal device 102, and from the base station apparatus 100-3 to the terminal device 103 (step s206). The base station apparatus 100-1 notifies the base station apparatus 100-3 of the determined terminal information (step s207). Support information to cancel interference in the terminal device is also notified at the same time the terminal information is notified. The support information includes interference MCS as MCS of an interfering base station. These pieces of information are also notified to the base station apparatus 100-2, though such step is not illustrated. The base station apparatus 100-3 notifies the terminal device 103 of the terminal information notified by the base station apparatus 100-1 (step s208). The base station apparatus 100-3 transmits data to the terminal device 103 in accordance with the notified terminal information (step s209). The terminal device 103 cancels the interference coming from the base station apparatuses 100-1 and 100-2 in accordance with the notified terminal information, and demodulates the data addressed thereto (step s210).

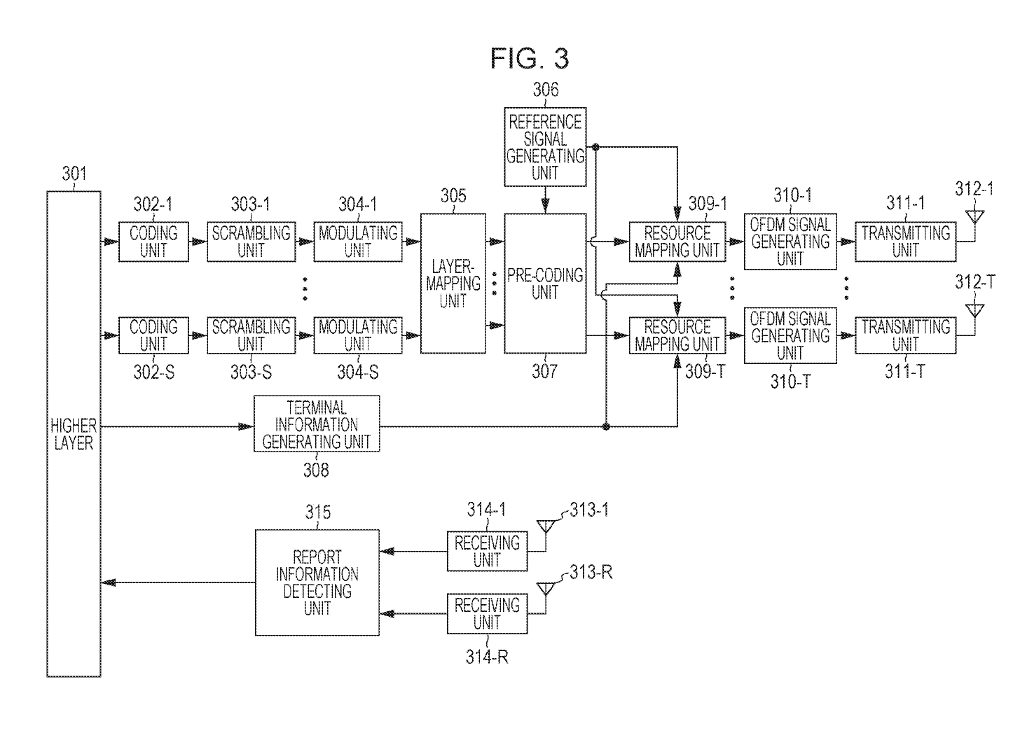

FIG. 3 is a block diagram diagrammatically illustrating a configuration of the base station apparatus 100-3 of the present embodiment. The base station apparatus 100-3 includes a higher layer 301, coding units 302-1 through 302-S, scrambling units 303-1 through 303-S, modulating units 304-1 through 304-S, a layer-mapping unit 305, a reference signal generating unit 306, a pre-coding unit 307, a terminal information generating unit 308, resource mapping units 309-1 through 309-T, OFDM signal generating units 310-1 through 310-T, transmitting units 311-1 through 311-T, transmit antennas 312-1 through 312-T, receive antennas 313-1 through 313-R, receiving units 314-1 through 314-R, and a report information detecting unit 315. Letters S, T, and R in FIG. 3 respectively represent the number of streams, the number of transmit antennas, and the number of receive antennas. If part or whole of the base station apparatus 100-3 is integrated into an integrated circuit as a chip, the base station apparatus 100-3 includes a chip control circuit configured to control each function of the blocks.

The higher layers 301 include a layer having a function higher than a physical layer, from among the layers having communication functions defined by OSI reference model. For example, the higher layers 301 includes a MAC (Media Access Control) layer, a data link layer, a network layer, and other layers. The higher layer 301 notifies the base station apparatus 100-3 another parameter that is needed for each element forming the base station apparatus 100-3 to implement the function thereof. The higher layer 301 also communicates with the base station apparatus 100-1.

The coding units 302-1 through 302-S error-correction code information data input from the higher layer 301, thereby generating a coded bit (codeword). The information data includes a voice signal for phone call, a still image or a moving image representing a captured image, and a text message. The coding scheme that the coding units 302-1 through 302-S use in the error-correction coding includes turbo coding, convolutional coding, or low density parity check coding (LDPC).

The coding units 302-1 through 302-S may perform rate matching on the coded bit sequence such that the coding rate of the error-correction coded data sequence matches a coding rate responsive to the data transmission rate. The coding units 302-1 through 302-S may have an interleave function to re-construct a data sequence that has been error-correction coded.

The scrambling units 303-1 through 303-S scramble the codewords input from the coding units 302-1 through 302-S in accordance with each cell ID.

The modulating units 304-1 through 304-S map the scrambled codewords to a modulation symbol. The modulation scheme performed by the modulating units 304-1 through 304-S includes BPSK (Binary Phase Shift Keying), QPSK (Quadrature Phase Shift Keying), or M-QAM (M-Quadrature Amplitude Modulation with M=16, 64, 256, 1024 or 4096). The modulating units 304-1 through 304-S may have an interleave function of re-constructing the generated modulation symbols.

The layer-mapping unit 305 layer-maps the modulation symbol for spatial multiplexing. For example, LTE-A (LTE-Advanced) supports a maximum of eight layers, and a single codeword is mapped to a maximum of four layers.

The reference signal generating unit 306 generates reference signals, and then outputs a reference signal in need of pre-coding to the pre-coding unit 307 and a reference signal free from pre-coding to the resource mapping units 309-1 through 309-T.

The pre-coding unit 307 performs a pre-coding operation on the output from the layer-mapping unit 305. Part of the reference signal, such as DMRS (DeModulation Reference Symbol, or UE-specific Reference Signal), may undergo the same pre-coding as the data signal that is to be demodulated.

The terminal information generating unit 308 outputs the terminal information notified by the base station apparatus 100-1 via the higher layer 301 to the resource mapping units 309-1 through 309-T. The terminal information includes the cell ID, MCS, reference signal, antenna port number, and resource allocation information. The terminal information generating unit 308 receives from the higher layer 301 support information including interference MCS and outputs the support information to the resource mapping units 309-1 through 309-T at the same time when the terminal information is received and transmitted. The modulation scheme at that time may be used instead of interference MCS. Since an amount of information corresponding to the coding rate is reduced, the number of bits for notifying the support information is reduced. The terminal device 103 may perform interference cancellation and demodulation operation in accordance with the support information. The interfering base station represents a base station apparatus from which a terminal device receives an interference signal. In the present embodiment, the interfering base stations of the terminal device 103 are the base station apparatuses 100-1 and 100-2. The terminal information may be the control information.

The resource mapping units 309-1 through 309-T map the output of the pre-coding unit 307, the reference signal, and the terminal information to resources.

The OFDM (Orthogonal Frequency Division Multiplexing) signal generating units 310-1 through 310-T perform an IFFT (Inverse Fast Fourier Transform) operation on and insert a cyclic prefix (CP) into the output of the resource mapping units 309-1 through 309-T. The resource mapping units 309-1 through 309-T thus generate OFDM signals. The transmitting units 311-1 through 311-T perform an analog-to-digital conversion operation, a filtering operation, a frequency conversion, and other operations on the generated OFDM signal, and the resulting signals are transmitted through the transmit antennas 312-1 through 312-T.

The base station apparatus 100-3 also has a function of receiving signals. The receive antennas 313-1 through 313-R receive a signal from the terminal device 103, and the receive antennas 313-1 through 313-R perform a frequency conversion operation, a filtering operation, an analog-to-digital conversion operation, and other operation on the received signal. The report information detecting unit 315 detects the quality information fed back from the terminal device 103. The quality information detected is reported to the base station apparatus 100-1 via the higher layer 301. The base station apparatus 100-1 acquires the first CQI, PMI, RI, and interference CQI in this way. The base station apparatus 100-1 also has acquired the first CQI, PMI, RI, and interference CQI with the terminal devices 101 and 102 in the same way. Not only the first CQI from the terminal device 102 but also the interference CQIS from the terminal device 103 and the terminal device 101 may be used to select the MCS of the terminal device 102. For example, an MCS having the lowest transmission rate from among the three MCSs may be selected. In this way, the terminal devices 103 and 101 may cancel interference from the base station apparatus 100-2, thereby improving transmission performance.

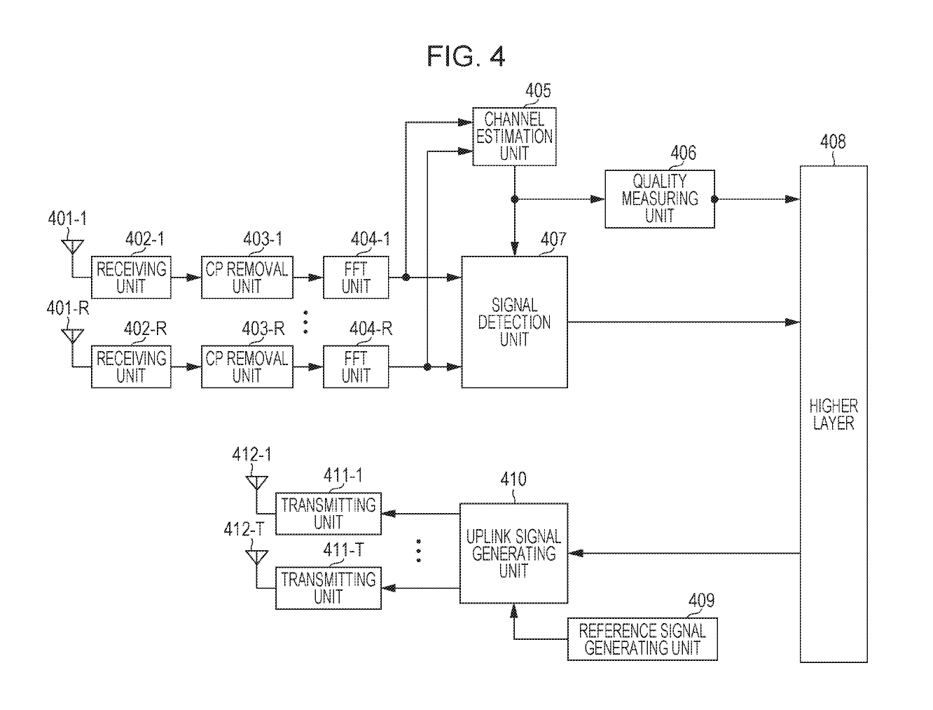

FIG. 4 is a block diagram diagrammatically illustrating a configuration of the terminal device 103 of the present embodiment. The terminal device 103 includes receive antennas 401-1 through 401-R, receiving units 402-1 through 401-R, CP removal units 403-1 through 403-R, FFT units 404-1 through 404-R, a channel estimation unit 405, a quality measuring unit 406, a signal detection unit 407, a higher layer 408, a reference signal generating unit 409, an uplink signal generating unit 410, transmitting units 411-1 through 411-T, and transmit antennas 412-1 through 412-T. If part or whole of the terminal device 103 is integrated into an integrated circuit as a chip, the terminal device 103 may include a chip control circuit (not illustrated) to control each function block. The number of transmit antennas T, and the number of receive antennas R are designated in the same way as in the base station apparatus 100-3. The numbers of antennas may or may not be equal between the terminal device and the base station apparatus.

In the terminal device 103, the receive antennas 401-1 through 401-R receive signals, and the receiving units 402-1 through 402-R perform a frequency conversion operation, a filtering operation, an analog-to-digital conversion operation, and other operation on the received signals. The CP removal units 403-1 through 403-R remove the cyclic prefix from the outputs from the receiving units 402-1 through 402-R, and the FFT units 404-1 through 404-R perform time-frequency transform. The channel estimation unit 405 performs channel estimation of the base station apparatuses 100-1, 100-2, and 100-3 using CSI-RS (Channel State Information—Reference Signal). The estimation results are output to the quality measuring unit 406. In a case that the base station apparatus 100-3 transmits data, the channel estimation unit 405 determines a channel estimation value for demodulation using the DMRS. If the DMRS is pre-coded, the channel estimation value accounting for the pre-coding is determined. The quality measuring unit 406 performs quality measurement using the channel estimation value input from the channel estimation unit 405, and thus generates the CQI, PMI, and RI of the base station apparatus 100-3. Also, the quality measuring unit 406 generates the interference CQIs of the base station apparatuses 100-1 and 100-2. These pieces of quality information are output to the higher layer 408. The signal detection unit 407 cancels the interference signals from the base station apparatus 100-1 and the base station apparatus 100-2, determines information data transmitted thereto, and outputs the information data to the higher layer 408. In this case, the signal detection unit 407 cancels the interference signals using the MCS and RI of the base station apparatus 100-1 and the base station apparatus 100-2 included in the terminal information notified by the base station apparatus 100-3. The signal detection unit 407 performs a demodulation operation using the MCS and RI included in the terminal information notified by the base station apparatus 100-3.

The terminal device 103 also has a function of transmitting a signal. The reference signal generating unit 409 generates an uplink reference signal. The uplink signal generating unit 410 generates an uplink signal based on the information data acquired from the higher layer, the parameter for generating the uplink signal, the reference signal acquired from the reference signal generating unit 409, and the quality information to be reported to the base station apparatus 100-3. The quality information includes the first CQI, the first PMI, the first RI for the terminal device 103, the interference CQI and other information. Since the base station apparatus 100-1 performs the scheduling operation in view of the reference CQI, the terminal device 103 is allowed to cancel the interference at a higher accuracy level. This operation principle is described below. Note that the uplink signal includes an SC-FDMA symbol and an OFDMA symbol. The transmitting unit 411-1 through 411-T perform a digital-to-analog conversion operation, a filtering operation, a frequency conversion operation, and other operation on the output of the uplink signal generating unit 410, and the resulting signals are transmitted via the transmit antennas 412-1 through 412-T.

### Operation Principle

The operation principle of the first embodiment of the present invention is described below. A R-th dimensional reception signal vector r in a given resource element in the terminal device 103 is expressed in the following formula (1).

[Math]

r=H₁s₁+H₂s₂+H₃s₃+n (1)

Note that the resource element represents a single subcarrier in an OFDM symbol, and is a physical resource to which a modulation symbol or a reference signal is allocated. Respectively represented by s₁, s₂, and s₃ are transmission signal vectors from the base station apparatuses 100-1, 100-2, and 100-3, and the sizes thereof are the number of streams from the base station apparatuses. In this case, s₁ and s₂ respectively represent data to the terminal devices 101 and 102, and serve as interference to the terminal device 103. H₁, H₂, and H₃ respectively represent channel matrices from the base station apparatuses 100-1, 100-2, and 100-3 to the terminal device 103. The vertical size of these matrices is R. The horizontal sizes of H₁, H₂, and H₃ match the sizes of s₁, s₂, and s₃. Furthermore, n represents a R-th dimensional noise vector.

The terminal device 103 demodulates s₃. To this end, s₁ or s₂ is demodulated to produce the replica thereof as an interference replica. The terminal device 103 then remove the interference replica from the received signal. In this way, S₃ is demodulated in an interference-free state, and the transmission characteristics are thus improved. The interference replica may be a demodulation result of s₁ or s₂, or may be a decoding result obtained using the demodulation result. The demodulation result or the decoding result used as an interference replica may be a hard-decision value or a soft-decision value.

In the interference demodulation process, the MCS is preferably set up such that s₁ and s₂ are demodulated by the terminal device 103. For this reason, the quality measuring unit in the terminal device 103 determines the interference CQI to the base station apparatuses 100-1 and 100-2, and reports the interference CQIs to the base station apparatus 100-3. This step corresponds to step s204 as illustrated in FIG. 2. The CQI of the base station apparatus 100-3 may be determined on an assumption that interference is cancelable, or may be determined by estimating the interference cancellation accuracy level in the interference CQI.

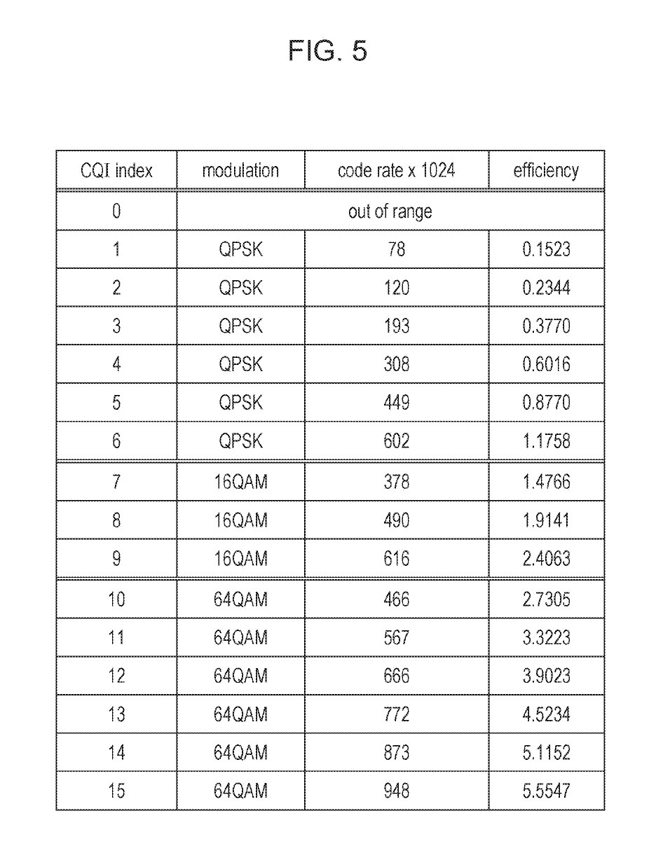

FIG. 5 illustrates an example of CQI. Specific CQI indexes include 0 from 15, and are values each terminal devices is to report. The higher index, the higher data rate. For example, in formula (1), CQI 8 indicates that H₁s₁ and H₂s₂ are interference that is difficult to cancel at a higher accuracy level. In the case of CQI 9 in which H₁s₁ and H₂s₂ are cancelable at a higher accuracy level, the data rate is increased if the interference cancellation is performed at a higher accuracy level.

Note that the base station apparatus 100-1 generates the terminal information based on the report from each terminal device, but particular information may be disregarded. For example, a maximum CQI of s₂ at which the terminal device 103 is able to perform a demodulation operation may be 2. If the base station apparatus 100-1 generates the terminal information in accordance with the CQI of 2, the MCS from the base station apparatus 100-2 to the terminal device 102 is substantially reduced, thereby reducing the data rate. In such a case, the report from the terminal device 103 may not be used. If CQI is as small as 2, H₂s₂ is sufficiently low power. Even if H₂s₂ is suppressed through noise approximation, the demodulation of s₃ is not affected.

In accordance with the present embodiment, the terminal device feeds back the second CQI to the base station apparatus. For this reason, the terminal device is allowed to cancel interference, thus substantially increasing the data rate.

The signal detection unit 407 determines s₁, s₂, and s₃ in the detection process. The detection process may include ZF (Zero Forcing), MMSE (Minimum Mean Squared Error), SIC (Successive Interference Cancellation), Turbo-SIC, PIC (Parallel Interference Cancellation), turbo-PIC, MLD (Maximum Likelihood Detection), QRM-MLD (QR decomposition and M algorithm-MLD), or Sphere Decoding.

In the discussion of the first embodiment, the base station apparatus 100-1 serving as a macro base station determines the terminal information to each terminal device. Alternatively, the low-power base station may determine the terminal information, and the macro base station may not necessarily have to determine the terminal information.

In the discussion of the first embodiment, the terminal device 103 reports the first CQI and the second CQI at the same timing. Alternatively, the terminal device 103 may report the CQIs at different timings. For example, the period of reporting the first CQI may be different from the period of reporting the second CQI. Since the second CQI is not the information that is used in the demodulation of the data, the period of reporting may be lengthened. In this way, an amount of information that the terminal device 103 reports is reduced.

In the discussion of the first embodiment, the terminal device feeds back the second CQI to the base station apparatus. Alternatively, the base station apparatus may request the terminal device to report the second CQI. In such a case, the base station apparatus may request the terminal device at the same timing to transmit the first CQI and the second CQI. This arrangement frees the base station apparatus from requesting the first CQI and the second CQI with one CQI differentiated from another CQI, thereby reducing an amount of information for requesting. Alternatively, the base station apparatus may configure different periods, one period for the first CQI and another period for the second CQI. In this way, the second CQI is reported at a timing of need, and an amount of feedback information is reduced.

Note that the second CQI may be fed back as a difference from the first CQI. This is true of the following embodiments.

Note that the base station apparatus may notify the interference MCS prior to the notification of the terminal information, and determine the first CQI in accordance with the interference MCS.

The terminal device 103 may report ACK/NACK information to the base station apparatus 100-3 concerning whether an error is contained in the information demodulated by the terminal device 103, and the base station apparatus 100-3 controls the quality information to be reported to the base station apparatus 100-1 in accordance with the ACK/NACK information. If the base station apparatus 100-3 receives from the terminal device 103 NACK that indicates an error, the CQI number of the terminal device 103 reported heretofore to the base station apparatus 100-1 may be lowered by one.

The first CQI and the second CQI may be quoted from different tables. For example, the second CQI may be for a modulation scheme only, and the second CQI may be a binary index indicating the magnitude of the interference. In this way, the second CQI is configured to be smaller than the first CQI in the amount of feedback information.

### Second Embodiment

In a method of a second embodiment, the terminal device feeds back not only the interference CQI as second channel information but also the CQI for the terminal device with no interference canceled (a third CQI or a third channel quality indicator).

More specifically, an operation of reporting the quality information with the third CQI included therewithin is added to the quality information reporting in step s204 of the sequence chart (FIG. 2) of the sequence performed between the base station apparatus and the terminal device of the first embodiment.

The third CQI reported by each terminal device is used in the MCS determination in step s206. For example, it is assumed in formula (1) that the first CQI is 9, the third CQI is 8, and the second CQIs as the interference CQIs of the base station apparatuses 100-1 and 100-2 are 2. In such a case, the report from the terminal device 103 is desirably unused as the MCS of the base station apparatuses 100-1 and 100-2 determined by the base station apparatus 100-1 in order not to reduce the data rate. Since the third CQI has been reported from the terminal device 103, the third CQI may be used as the MCS of the base station apparatus 100-3 to be determined by the base station apparatus 100-1. The MCS determination by the base station apparatus 100-1 is this simplified.

In accordance with the present embodiment, the CQI with no interference canceled by each terminal device is fed back, and the MCS determination at the base station apparatus addressed to each terminal device is simplified.

In the second embodiment, the terminal device 103 reports the first CQI, the second CQI, and the third CQI at the same timing. But the first CQI, the second CQI, and the third CQI may be reported at different timings. For example, the period of reporting the first CQI and the third CQI may be different from the period of reporting the second CQI. Since the second CQI is not information to be used in the demodulation of data, the period of reporting the second CQI may be lengthened. In this way, the amount of information to be reported by the terminal device 103 may be decreased.

In accordance with the second embodiment, the terminal device feeds back the second CQI and the third CQI to the base station apparatus. Alternatively, the base station apparatus may request the terminal device to report the second CQI and the third CQI.

### Third Embodiment

In a method of a third embodiment described below, the terminal device feeds back not only the interference CQI as the second channel information but also a maximum rank number detected by the terminal device.

More specifically, an operation of reporting the quality information at the maximum rank of the terminal device 103 included therewithin is added to the quality information reporting in step s204 of the sequence chart (FIG. 2) of the sequence performed between the base station apparatus and the terminal device of the first embodiment.

In the MCS determination in step s206, a maximum rank reported by each terminal device is used. For example, the signal detection unit 407 (FIG. 4) in the terminal device 103 uses linear detection. If the maximum rank number detectable equals the number of receive antennas R, and the size of s₃ in formula (1) is R−2, each of the sizes of s₁ and s₂ is 1. Otherwise, the detection of s₁ and s₂ is difficult, and interference cancellation is difficult unless non-linear detection such as MLD is used.

If the terminal device 103 implements linear detection, the maximum rank number may be the number of receive antennas R. If the terminal device 103 implements non-linear detection, such as MLD, an implemented algorithm may configure the maximum rank number to be MIMO separable, and to be higher than R.

In contrast, in accordance with the present embodiment, the maximum rank number detectable by each terminal device may be fed back. The rank number determined by each base station apparatus to each terminal device is configured to be a number in which interference cancellation is possible. The interference cancellation through the linear detection is thus possible.

In accordance with the present embodiment, the third CQI described with reference to the second embodiment may be fed back.

In accordance with the present embodiment described above, a difference between the maximum rank and RI may be used in place of the maximum rank. In this way, the number of bits to be used in the reporting is reduced.

In accordance with the present embodiment described above, the terminal device feeds back the maximum rank number detectable by the terminal device to the base station apparatus. Alternatively, the base station apparatus requests the terminal device to report the maximum rank number. In this way, the maximum rank number is reported at a timing of need, and the amount of feedback information is reduced.

In accordance with the present embodiment described above, a rank of an interference channel (a second rank indication or a second RI) may be fed back. In this way, the base station apparatus 100-1 raises the accuracy level of the rank determination addressed to each terminal device in the production of the terminal information.

In the present embodiment, the base station apparatus may request the terminal device to report the second RI. In such a case, the period of requesting the second CQI may be configured to be different from the period of requesting the second RI.

### Fourth Embodiment

In a method of a fourth embodiment described below, the terminal device feeds back not only the interference CQI as the second channel information but also an interference PMI as a PMI of the interference channel (a second pre-coding matrix indicator or a second PMI).

More specifically, the terminal device 103 adds an operation of determining the interference PMI, and reporting the quality information with the interference PMI included therewithin to the quality information reporting in step s204 of the sequence chart (FIG. 2) of the sequence performed between the base station apparatus and the terminal device of the first embodiment. The PMI that increases interference may be selected. In this way, the terminal device 103 may increase the demodulation accuracy of the interference signal.

The interference PMI reported by each terminal device may be used in the MCS determination in step s206.

In accordance with the present embodiment, each terminal device feeds back the interference PMI, and causes the pre-coding to each terminal device determined by the base station apparatus to effectively serve the interference cancellation. The interference cancellation performance is thus improved in the terminal device.

In the present embodiment, as well, the third CQI described in connection with the second embodiment may be fed back.

In the present embodiment, as well, the maximum rank number described in connection with the third embodiment may be fed back.

In the present embodiment, as well, the second RI described in connection with the third embodiment may be fed back.

In accordance with the present embodiment described above, the terminal device feeds back the second PMI to the base station apparatus. Alternatively, the base station apparatus may request the terminal device to report the second PMI. In this case, the base station apparatus may also request the terminal device to report the second RI. The period of requesting the second PMI may be configured to be equal to the period of requesting the second RI.

In accordance with the method of the first through fourth embodiments described above, multiple CQIs are fed back. Alternatively, a difference between one CQI and another CQI may be fed back. For example, if the first CQI is 8 and the second CQI is 7 in the second embodiment, the difference 1 and the first CQI may be fed back. In this way, the number of bits in the CQI report is reduced.

A program running on the macro base station 100-1, the low-power base stations 100-2, and 100-3, and the terminal devices 101, 102, and 103 of the present invention is a program that controls a CPU (a program for causing a computer to function) in a manner such that the functions of the embodiments of the present invention are implemented. Information handled by these apparatuses may be temporarily stored on a RAM during process, and then stored on a variety of ROMs or HDD. The information may be read, corrected, or written by the CPU as necessary. Recording media storing the program may include semiconductor memories (such as a ROM or a non-volatile memory card), optical recording media (such as DVD, MO, MD, CD, or BD), and magnetic recording media (such as a magnetic tape or a flexible disk). The functions of the embodiments are implemented by executing the loaded program. The functions of the invention may also be implemented in conjunction with an operating system or another application program in response to an instruction of the program.

To circulate the program in the market, the program may be supplied in a stored state on a portable recording medium, or is transferred to a server computer via a network such as the Internet. In such a case, a storage device in the server computer also falls within the scope of the present invention. Whole or part of the macro base station 100-1, the low-power base stations 100-2, and 100-3, and the terminal devices 101, 102, and 103 of the embodiments described with reference to the drawings may be implemented as LSI as a typical integrated circuit. Each function block in the macro base station 100-1, the low-power base stations 100-2, and 100-3, and the terminal devices 101, 102, and 103 may be individually integrated into a chip. Alternatively, all or some of the function blocks may be integrated into a chip. The integrated form may not be limited to LSI. The integrated form may be a dedicated circuit, or a general-purpose processor. If a technique of circuit integration replacing the LSI appears with the advance of semiconductor technique, an integrated circuit resulting from the technique may also be used.

The embodiments of the present invention have been described in detail with reference to the drawings. A specific structure of each embodiment is not limited to the structures described above. A variety of design changes is possible without departing from the scope of the present invention. A variety of modification is possible without departing from the scope of the prevent invention defined by the claims. An embodiment resulting from combining technical means disclosed in the different embodiments may also fall within the scope of the present invention. The embodiments include elements that may have similar functions, and if an embodiment is constructed by interchanging the elements having the similar functions, such an embodiment may also fall within the scope of the present invention.

The present invention is not limited to the above-described embodiments. The terminal device of the present invention is not limited to the mobile station apparatus. The terminal device of the present invention may be applied to an apparatus installed indoors or outdoors, or non-portable electronics, such as AV apparatus, kitchen equipment, cleaner and washing machine, air-conditioner, office equipment, vending machine, or other life support devices.

### INDUSTRIAL APPLICABILITY

The present invention appropriately finds applications in a base station apparatus, and a terminal device.

### REFERENCE SIGNS LIST

100-1 Macro base station
100-1a Macro cell
100-2, and 100-3 Low-power base stations
100-2a, and 100-3a Small cells
100-2b, and 100-3b Connections
101, 102, and 103 Terminal devices
301 and 408 Higher layers
302-1 through 302-S Coding units
303-1 through 303-S Scrambling units
304-1 through 304-S Modulating units
305 Layer-mapping unit
306 and 409 Reference signal generating units
307 Pre-coding unit
308 Terminal information generating unit
309-1 through 309-T Resource mapping units
310-1 through 310-T OFDM signal generating units
311-1 through 321-T, and 411-1 through 411-T Transmitting units
312-1 through 312-T, and 412-1 through 412-T Transmit antennas
313-1 through 313-R, and 401-1 through 401-R Receive antennas
314-1 through 314-R, and 402-1 through 402-R Receiving units
315 Report information detecting unit
403-1 through 403-R CP removal units
404-1 through 404-R FFT units
405 Channel estimation unit
406 Quality measuring unit
407 Signal detection unit
410 Uplink signal generating unit

1-30. (canceled)

31. A terminal device in communication with base station apparatuses, comprising:
a quality measuring unit configured to measure a first channel quality indicator serving as a channel quality indicator with a base station apparatus, and a second channel quality indicator serving as a channel quality with another base station apparatus other than the base station apparatus, and
a transmitting unit configured to transmit the first channel quality indicator and the second quality indicator to the base station apparatus.

32. The terminal device according to claim 31, wherein the transmitting unit transmits the second channel quality indicator to the base station apparatus in a case that the base station apparatus has requested the terminal device to report the second channel quality indicator.

33. The terminal device according to claim 31, wherein the transmitting unit transmits the first channel quality indicator and the second channel quality indicator at the same timing.

34. The terminal device according to claim 31, wherein the transmitting unit transmits the first channel quality indicator and the second channel quality indicator at different timings.

35. The terminal device according to claim 31, wherein the transmitting unit transmits the second channel quality indicator with a period longer than a period of transmitting the first channel quality indicator.

36. The terminal device according to claim 31, wherein the quality measuring unit determines one of the second channel quality indicator and the first channel quality indicator by estimating an interference cancellation accuracy level.

37. The terminal device according to claim 31, wherein the quality measuring unit determines one of the second channel quality indicator and the first channel quality indicator based on an assumption that interference is cancelable.

38. A base station apparatus in communication with a terminal device, comprising:
a terminal information generating unit configured to generate a first request requesting to report a first channel quality indicator serving as a channel quality indicator with the terminal device and a second request requesting to report a second channel quality indicator between an interfering base station different from the base station apparatus and the terminal device, and
a transmitting unit configured to transmit the first request and the second request to the terminal device.

39. The base station apparatus according to claim 38, wherein the transmitting unit transmits the first request and the second request as a single request.

40. The base station apparatus according to claim 38, wherein the transmitting unit transmits the first request and the second request as different requests.

41. The base station apparatus according to claim 38, further comprising a receiving unit configured to receive the first channel quality indicator and the second channel quality indicator from the terminal device,
wherein the receiving unit receives the second channel quality indicator with a period longer than a period of receiving the first channel quality indicator.

42. A communication method of a terminal device in communication with base station apparatuses, comprising:
a quality measuring step of measuring a first channel quality indicator serving as a channel quality indicator with a base station apparatus, and a second channel quality indicator serving as a channel quality with another base station apparatus other than the base station apparatus, and
a transmitting step of transmitting the first channel quality indicator and the second quality indicator to the base station apparatus.
